(19) United States
(12) Patent Application Publication
(10) Pub. No.: US 2025/0286682 A1
(43) Pub. Date: Sep. 11, 2025

(54) METHODS AND MECHANISMS FOR APERIODIC AND SEMI-PERSISTENT TRACKING REFERENCE SIGNALS (TRS)

(71) Applicant: Telefonaktiebolaget LM Ericsson (publ), Stockholm (SE)

(72) Inventors: Sina MALEKI, Malmö (SE); Ilmiawan SHUBHI, Malmö (SE)

(21) Appl. No.: 18/858,932

(22) PCT Filed: Apr. 27, 2023
(86) PCT No.: PCT/EP2023/061132

§ 371 Date: Oct. 22, 2024

Related U.S. Application Data
(60) Provisional application No. 63/336,154, filed on Apr. 28, 2022.

(51) Int. Cl. H04L 5/00; H04B 7/06

(52) U.S. Cl. CPC H04L 5/0051; H04B 7/0626

(57) ABSTRACT

A method, network node and wireless device (WD) for aperiodic and semi-persistent tracking reference signals. are disclosed. According to one aspect, a method in a network node includes configuring a tracking reference signal, TRS, resource set for one of: semi-persistent TRS signaling; aperiodic TRS signaling unassociated with periodic reference signaling; and TRS signaling upon request by the WD. The method also includes transmitting the TRS resource set configuration to the WD.

### TECHNICAL FIELD

The present disclosure relates to wireless communications, and in particular, to aperiodic and semi-persistent tracking reference signals.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, Radio Access Networks (RANs), such as a New Generation Radio Access Network (NG-RAN), broadband communication between network nodes, such as a Next Generation Node B (gNB), and mobile wireless devices (WD), as well as communication between network nodes and between WDs.

In 3GPP Technical Release 15 (3GPP Rel-15) NR, a WD may be configured with up to four carrier bandwidth parts (BWPs) in the downlink with a single downlink carrier bandwidth part being active at a given time. A WD may also be configured with up to four carrier bandwidth parts in the uplink with a single uplink carrier bandwidth part being active at a given time. If a WD is configured with a supplementary uplink, the WD may additionally be configured with up to four carrier bandwidth parts in the supplementary uplink with a single supplementary uplink carrier bandwidth part being active at a given time.

For a carrier bandwidth part with a given numerology μᵢ, a contiguous set of physical resource blocks (PRBs) are defined and numbered from 0 to N_{BWPi}^{size}−1 where i is the index of the carrier bandwidth part. A resource block (RB) is defined as 12 consecutive subcarriers in the frequency domain.

Multiple orthogonal frequency-division multiplexing (OFDM) numerologies, μ, are supported in NR as given by Table 1, where the subcarrier spacing, Δf, and the cyclic prefix for a carrier bandwidth part are configured by different higher layer parameters for downlink (DL) and uplink (UL), respectively. Table 1 shows supported transmission numerologies.

TABLE 1
Supported transmission numerologies.

| μ | Δf = 2^{μ} · 15 [kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

### Physical Channels

A downlink physical channel corresponds to a set of resource elements carrying information originating from higher layers. One or more of the following downlink physical channels are defined:
Physical Downlink Shared Channel, PDSCH;
Physical Broadcast Channel, PBCH; and
Physical Downlink Control Channel, PDCCH.

PDSCH is the main physical channel used for unicast downlink data transmission, but also for transmission of RAR (random access response), certain system information blocks, and paging information. PBCH carries the basic system information, required by the WD to access the network. PDCCH is used for transmitting downlink control information (DCI), mainly scheduling decisions, required for reception of PDSCH, and for uplink scheduling grants enabling transmission on PUSCH.

An uplink physical channel corresponds to a set of resource elements carrying information originating from higher layers. One or more of the following uplink physical channels may be defined:
Physical Uplink Shared Channel, PUSCH;
Physical Uplink Control Channel, PUCCH; and
Physical Random Access Channel, PRACH; and

PUSCH is the uplink counterpart to the PDSCH. PUCCH is used by WDs to transmit uplink control information, including hybrid automatic repeat request (HARQ) acknowledgements, channel state information (CSI) reports, etc. PRACH is used for random access preamble transmission.

### Nr Reference Symbols

The ultra-lean design principle in NR aims to minimize the always-on transmissions that exists in earlier systems (e.g., LTE cell-specific reference signal (CRS) reference symbols). Instead, NR provides reference symbols such as synchronization signal (SS) blocks (SSBs) on a periodic basis, by default once every 20 ms. In addition, for connected mode WDs, typically a set of reference symbols are provided for optimal link performance. Some of these reference symbols are described below.

### CSI-RS for Tracking

A WD in radio resource control (RRC) connected mode is expected to receive from the NW (i.e., network, network node, etc.) the RRC layer WD specific configuration of an NZP-CSI-RS-ResourceSet configured including the parameter trs-Info. For an NZP-CSI-RS-ResourceSet configured with the higher layer parameter trs-Info set to “true”, the WD may assume the antenna port with the same port index of the configured non-zero power channel state information reference signal (NZP CSI-RS) resources in the NZP-CSI-RS-ResourceSet is the same.

For frequency range 1 (FR1), the WD may be configured with one or more NZP CSI-RS set(s), where an NZP-CSI-RS-ResourceSet consists of four periodic NZP CSI-RS resources in two consecutive slots with two periodic NZP CSI-RS resources in each slot. If no two consecutive slots are indicated as downlink slots by tdd-UL-DL-ConfigurationCommon or tdd-UL-DL-ConfigDedicated, then the WD may be configured with one or more NZP CSI-RS set(s), where an NZP-CSI-RS-ResourceSet consists of two periodic NZP CSI-RS resources in one slot; and
For frequency range 2 (FR2), the WD may be configured with one or more NZP CSI-RS set(s), where an NZP-CSI-RS-ResourceSet consists of two periodic CSI-RS resources in one slot or with an NZP-CSI-RS-ResourceSet of four periodic NZP CSI-RS resources in two consecutive slots with two periodic NZP CSI-RS resources in each slot.

A WD configured with NZP-CSI-RS-ResourceSet(s) configured with higher layer parameter trs-Info may have the CSI-RS resources configured as:
Periodic, with the CSI-RS resources in the NZP-CSI-RS-ResourceSet configured with same periodicity, bandwidth and subcarrier location; and/or
Periodic CSI-RS resource in one set and aperiodic CSI-RS resources in a second set, with the aperiodic CSI-RS and periodic CSI-RS resource having the same bandwidth (with same resource block (RB) location) and the aperiodic CSI-RS being ‘QCL-Type-A’ and ‘QCL-TypeD’, where applicable, with the periodic CSI-RS resources. For frequency range 2, the WD does not expect that the scheduling offset between the last symbol of the PDCCH carrying the triggering downlink control information (DCI) and the first symbol of the aperiodic CSI-RS resources is smaller than the WD reported ThresholdSched-Offset. The WD may expect that the periodic CSI-RS resource set and aperiodic CSI-RS resource set are configured with the same number of CSI-RS resources and with the same number of CSI-RS resources in a slot. For the aperiodic CSI-RS resource set, if triggered, and if the associated periodic CSI-RS resource set is configured with four periodic CSI-RS resources with two consecutive slots with two periodic CSI-RS resources in each slot, the higher layer parameter aperiodicTriggeringOffset indicates the triggering offset for the first slot for the first two CSI-RS resources in the set.

A WD does not expect to be configured with a CSI-ReportConfig that is linked to a CSI-ResourceConfig containing an NZP-CSI-RS-ResourceSet configured with trs-Info and with the CSI-ReportConfig configured with the higher layer parameter time RestrictionForChannelMeasurements set to ‘configured’. A WD does not expect to be configured with a CSI-ReportConfig with the higher layer parameter reportQuantity set to other than ‘none’ for aperiodic NZP CSI-RS resource set configured with trs-Info. A WD does not expect to be configured with a CSI-ReportConfig for periodic NZP CSI-RS resource set configured with trs-Info. Further, a WD does not expect to be configured with an NZP-CSI-RS-ResourceSet configured both with trs-Info and repetition.

Each CSI-RS resource, defined, for example, in Clause 7.4.1.5.3 of 3GPP TS 38.211, may be configured by the higher layer parameter NZP-CSI-RS-Resource with the following restrictions:
the time-domain locations of the two CSI-RS resources in a slot, or of the four CSI-RS resources in two consecutive slots (which are the same across two consecutive slots), as defined by higher layer parameter CSI-RS-resourceMapping, is given by one of:
   l∈{4,8}, l∈{5,9}, or l∈{6,10} for frequency range 1 and frequency range 2;
   l∈{0,4}, l∈{1,5}, l∈{2,6}, l∈{3,7}, l∈{7,11}, l∈{8,12} or l∈{9,13} for frequency range 2;
a single port CSI-RS resource with density ρ=3 given by Table 7.4.1.5.3-1 from 3GPP TS 38.211 and higher layer parameter density configured by CSI-RS-ResourceMapping;
the bandwidth of the CSI-RS resource, as given by the higher layer parameter freqBand configured by CSI-RS-ResourceMapping, is the minimum of 52 and N_{BWP,i}^{size} resource blocks, or is equal to N_{BWP,i}^{size} resource blocks. For operation with shared spectrum channel access, freqBand configured by CSI-RS-ResourceMapping, is the minimum of 48 and N_{BWP,i}^{size} resource blocks, or is equal to N_{BWP,i}^{size} resource blocks;
the WD is not expected to be configured with the periodicity of 2^{μ}×10 slots if the bandwidth of CSI-RS resource is larger than 52 resource blocks;
the periodicity and slot offset for periodic NZP CSI-RS resources, as given by the higher layer parameter periodicityAndOffset configured by NZP-CSI-RS-Resource, is one of 2^{μ}Xₚ slots where Xₚ=10, 20, 40, or 80 and where μ is defined in Clause 4.3 of 3GPP TS 38.211; and
same powerControlOffset and powerControlOffsetSS given by NZP-CSI-RS-Resource value across all resources.

### NZP CSI-RS

The WD may be configured with one or more NZP CSI-RS resource set configuration(s) as indicated by the higher layer parameters CSI-ResourceConfig, and NZP-CSI-RS-ResourceSet. Each NZP CSI-RS resource set consists of K≥1 NZP CSI-RS resource(s).

The following parameters for which the WD may assume non-zero transmission power for CSI-RS resource are configured via the higher layer parameter NZP-CSI-RS-Resource, CSI-ResourceConfig and NZP-CSI-RS-ResourceSet for each CSI-RS resource configuration:
nzp-CSI-RS-ResourceId determines CSI-RS resource configuration identity;
periodicityAndOffset defines the CSI-RS periodicity and slot offset for periodic/semi-persistent CSI-RS. All the CSI-RS resources within one set are configured with the same periodicity, while the slot offset may be same or different for different CSI-25 RS resources;
resourceMapping defines the number of ports, CDM-type, and OFDM symbol and subcarrier occupancy of the CSI-RS resource within a slot that are given in, for example, Clause 7.4.1.5 of 3GPP Technical Standard (TS) 38.211;
nrofPorts in resourceMapping defines the number of CSI-RS ports, where the allowable values are given in Clause 7.4.1.5 of 3GPP TS 38.211;
density in resourceMapping defines CSI-RS frequency density of each CSI-RS port per physical resource block (PRB), and CSI-RS PRB offset in case of the density value of ½, where the allowable values are given in, for example, Clause 7.4.1.5 of 3GPP TS 38.211. For density ½, the odd/even PRB allocation indicated in density is with respect to the common resource block grid;
cdm-Type in resourceMapping defines code division multiplex (CDM) values and patterns, where the allowable values are given in, for example, Clause 7.4.1.5 of 3GPP TS 38.211;
powerControlOffset: which is the assumed ratio of PDSCH energy per resource element (EPRE) to NZP CSI-RS EPRE when WD derives CSI feedback and takes values in the range of [−8, 15] dB with 1 dB step size;
powerControlOffsetSS: which is the assumed ratio of NZP CSI-RS EPRE to SS/PBCH block EPRE;
scramblingID defines scrambling ID of CSI-RS with length of 10 bits.
BWP-Id in CSI-ResourceConfig defines which bandwidth part the configured CSI-RS is located in;
repetition in NZP-CSI-RS-ResourceSet is associated with a CSI-RS resource set and defines whether the WD may assume that the CSI-RS resources within the NZP CSI-RS Resource Set are transmitted with the same downlink spatial domain transmission filter, for example, as described in Clause 5.1.6.1.2. of 3GPP TS 38.211 and may be configured only when the higher layer parameter reportQuantity associated with all the reporting settings linked with the CSI-RS resource set is set to ‘cri-RSRP’, ‘cri-SINR’ or ‘none’;
qcl-InfoPeriodicCSI-RS contains a reference to a TCI-State indicating QCL source RS(s) and QCL type(s). If the TCI-State is configured with a reference to an RS with ‘QCL-TypeD’ association, that RS may be an SS/PBCH block located in the same or different CC/DL BWP or a CSI-RS resource configured as periodic located in the same or different CC/DL BWP;
trs-Info in NZP-CSI-RS-ResourceSet is associated with a CSI-RS resource set and for which the WD 22 may assume that the antenna port with the same port index of the configured NZP CSI-RS resources in the NZP-CSI-RS-ResourceSet is the same as described in Clause 5.1.6.1.1 of 3GPP TS 38.211 and may be configured when reporting setting is not configured or when the higher layer parameter reportQuantity associated with all the reporting settings linked with the CSI-RS resource set is set to ‘none’.

All CSI-RS resources within one set are configured with same density and same nrofPorts, except for the NZP CSI-RS resources used for interference measurement.

The WD expects that all the CSI-RS resources of a resource set are configured with the same starting RB and number of RBs and the same cdm-type.

The bandwidth and initial common resource block (CRB) index of a CSI-RS resource within a BWP, for example, as defined in Clause 7.4.1.5 of 3GPP TS 38.211, are determined based on the higher layer parameters nrofRBs and startingRB, respectively, within the CSI-FrequencyOccupation IE configured by the higher layer parameter freqBand within the CSI-RS-ResourceMapping IE. Both nrofRBs and startingRB are configured as integer multiples of 4 RBs, and the reference point for startingRB is CRB 0 on the common resource block grid. If startingRB<N_{BWP}^{start}, the WD 22 may assume that the initial CRB index of the CSI-RS resource is N_{initial RB}=N_{BWP}^{start}, otherwise N_{initial RB}=startingRB. If nrofRBs>N_{BWP}^{size}+N_{BWP}^{start}−N_{initial RB}, the WD 22 may assume that the bandwidth of the CSI-RS resource is N_{CSI-RS}^{BW}=N_{BWP}^{size}+N_{BWP}^{start}−N_{initial RB}, otherwise N_{CSI-RS}^{BW}=nrofRBs. In all cases, the WD may expect that N_{CSI-RS}^{BW}≥min (24, N_{BWP}^{size}).

Periodic transmission of reference signals impacts network power consumption. For example, a CSI-RS for tracking or tracking reference signal (TRS) is one of the periodic RSs which is configured and transmitted on a periodic basis, e.g., every 10, 20, 40 or 80 ms. A WD may be configured with a TRS with periodicity of 10 ms, which means that the network node has to transmit the TRS every 10 ms, and thus cannot go to deeper sleep modes in case there is no activity planned in between. Furthermore, the WD may not actually use all the transmitted TRSs considering an NR WD has access to many other RSs, e.g., demodulation reference signal (DM-RS), SSB, etc. On the other hand, if the WD is configured with the longer periodicities, e.g., 80 ms, this may degrade the WD performance. Currently, it is only possible to change the TRS periodicity through RRC reconfiguration which is power and time consuming for both network node and the WD and is not as dynamic as needed.

In addition to periodicity, the WD may be configured with more than one TRS resource set with different TCI states, while the WD may be stationary and do not use most of TRS sets which are not within the beam currently covering the WDs area. As such, the TRSs are being transmitted but not used by the WD.

Aperiodic TRS exists in current 3GPP specifications, but only for FR2 and also only in addition to configuration of a periodic TRS resource set.

### SUMMARY

Some embodiments advantageously provide methods, network nodes and wireless devices for aperiodic and semi-persistent tracking reference signals, e.g., for a TRS to be transmitted when and where needed on a faster pace than what RRC reconfiguration allows.

In some embodiments, the network node may decide (i.e., determine) to transmit on a need basis (e.g., based on a predetermined condition or mode) rather than on a purely periodic basis.

In some other embodiments, the following may be used:
Semi-persistent TRS: Open Systems Interconnection (OSI) L1 or L2 signaling is used to activate or deactivate one or more TRS resource (sets);
Aperiodic TRS: L1 or implicit signaling is used to indicate to the WD that one or more TRS resource (sets) are transmitted in the configured or indicated occasions; and/or
TRS transmission based on WD request: the WD requests the TRS to be transmitted optionally with a prohibit timer.

In some embodiments, the NW (network, network node) is configured to transmit the TRS on an as-needed basis instead of periodically to help the WD to maintain time/frequency (T/F) synchronization while also providing the network node with the opportunity to gain additional network node energy savings by gaining more and longer sleep times, e.g., when compared with typical systems.

According to one aspect, a method in a network node configured to communicate with a wireless device, WD, is provided. The method includes configuring a tracking reference signal, TRS, resource set for one of: semi-persistent TRS signaling; aperiodic TRS signaling unassociated with periodic reference signaling; and TRS signaling upon request by the WD; and transmitting the TRS resource set configuration to the WD.

According to this aspect, in some embodiments, the method includes configuring the WD with at least one semi-persistent non-zero power channel state information reference signal, NZP-CSI-RS, resource set. In some embodiments, the method includes one of activating and deactivating at least one semi-persistent TRS resource set by one of L1 and L2 signaling. In some embodiments, one of activating and deactivating at least one semi-persistent TRS resource set is based at least in part on channel conditions. In some embodiments, the method includes configuring the WD with a validity timer indicating a duration of activation of a semi-persistent resource set, the duration of activation being relative to a reference time. In some embodiments, the reference time is a system frame number. In some embodiments, the method includes configuring the WD with a minimum scheduling threshold before which an aperiodic TRS is not expected to be received by the WD. In some embodiments, the method includes transmitting to the WD a TRS together with a physical downlink shared channel, PDSCH, scheduling assignment. In some embodiments, the method includes configuring the WD with a repetition parameter indicating a number of repetitions of an aperiodic TRS resource set. In some embodiments, the method includes triggering an aperiodic TRS by downlink control information, DCI, signaling. In some embodiments, the method includes configuring at least one TRS resource set requested by the WD. In some embodiments, the method includes configuring a repetition pattern of TRS resources, the repetition pattern being requested by the WD. In some embodiments, the method includes configuring the WD with a set of TRS periodicities from which a TRS periodicity is selected by the WD. In some embodiments, the method includes transmitting to the WD the TRS with the TRS periodicity selected by the WD. In some embodiments, the method includes configuring the WD with a prohibition timer prohibiting the WD from transmitting the request for TRS signaling before expiry of the prohibition timer.

According to another aspect, a network node configured to communicate with a wireless device, WD, is provided. The network node includes processing circuitry configured to configure a tracking reference signal, TRS, resource set for one of: semi-persistent TRS signaling; aperiodic TRS signaling unassociated with periodic reference signaling; and TRS signaling upon request by the WD. The network node also includes a radio interface in communication with the processing circuitry and configured to transmit the TRS resource set configuration to the WD.

According to this aspect, in some embodiments, the processing circuitry is further configured to configure the WD with at least one semi-persistent non-zero power channel state information reference signal, NZP-CSI-RS, resource set. In some embodiments, the processing circuitry is further configured to one of activate and deactivate at least one semi-persistent TRS resource set by one of L1 and L2 signaling. In some embodiments, one of activating and deactivating at least one semi-persistent TRS resource set is based at least in part on channel conditions. In some embodiments, the processing circuitry is further configured to configure the WD with a validity timer indicating a duration of activation of a semi-persistent resource set, the duration of activation being relative to a reference time. In some embodiments, the reference time is a system frame number. In some embodiments, the processing circuitry is further configured to configure the WD with a minimum scheduling threshold before which an aperiodic TRS is not expected to be received by the WD. In some embodiments, the radio interface is further configured to transmit to the WD a TRS together with a physical downlink shared channel, PDSCH, scheduling assignment. In some embodiments, the processing circuitry is further configured to configure the WD with a repetition parameter indicating a number of repetitions of an aperiodic TRS resource set. In some embodiments, the processing circuitry is further configured to trigger an aperiodic TRS by downlink control information, DCI, signaling. In some embodiments, the processing circuitry is further configured to configure at least one TRS resource set requested by the WD. In some embodiments, the processing circuitry is further configured to configure a repetition pattern of TRS resources, the repetition pattern being requested by the WD. In some embodiments, the processing circuitry is further configured to configure the WD with a set of TRS periodicities from which a TRS periodicity is selected by the WD. In some embodiments, the radio interface is further configured to transmit to the WD the TRS with the TRS periodicity selected by the WD. In some embodiments, the processing circuitry is further configured to configure the WD with a prohibition timer prohibiting the WD from transmitting the request for TRS signaling before expiry of the prohibition timer.

According to yet another aspect, a method in a wireless device, WD, configured to communicate with a network node is provided. The method includes: receiving a tracking reference signal, TRS, resource set configuration for one of: semi-persistent TRS signaling; aperiodic TRS signaling unassociated with periodic reference signaling; and TRS signaling upon request by the WD. The method also includes configuring at least one TRS resource set according to the TRS resource set configuration.

According to this aspect, in some embodiments, the method includes receiving from the network node an instruction to one of activate and deactivate at least one semi-persistent TRS resource set by one of L1 and L2 signaling. In some embodiments, the method includes receiving from the network node a validity timer indicating a duration of activation of a semi-persistent resource set and activating the semi-persistent resource set for the duration. In some embodiments, the duration of activation is relative to a system frame number. In some embodiments, the method includes receiving from the network node a minimum scheduling threshold before which an aperiodic TRS is not expected to be received by the WD. In some embodiments, the method includes receiving from the network node a repetition parameter indicating a number of repetitions of an aperiodic TRS resource set. In some embodiments, the method includes transmitting to the network node a repetition pattern request requesting a repetition pattern of TRS resources. In some embodiments, the method includes selecting a TRS periodicity from a set of TRS periodicities and transmitting to the network node an indication of the selected TRS periodicity. In some embodiments, the method includes receiving from the network node a prohibition timer and refraining from transmitting the request for TRS signaling before expiry of the prohibition timer.

According to another aspect, a WD configured to communicate with a network node. The WD includes a radio interface configured to receive a tracking reference signal, TRS, resource set configuration for one of: semi-persistent TRS signaling; aperiodic TRS signaling unassociated with periodic reference signaling; and TRS signaling upon request by the WD. The WD includes processing circuitry in communication with the radio interface and configured to configure at least one TRS resource set according to the TRS resource set configuration.

According to this aspect, in some embodiments, the radio interface is further configured to receive from the network node an instruction to one of activate and deactivate at least one semi-persistent TRS resource set by one of L1 and L2 signaling. In some embodiments, the radio interface is further configured to receive from the network node a validity timer indicating a duration of activation of a semi-persistent resource set and wherein the processing circuitry is further configured to activate the semi-persistent resource set for the duration. In some embodiments, the duration of activation is relative to a system frame number. In some embodiments, the radio interface is further configured to receive from the network node a minimum scheduling threshold before which an aperiodic TRS is not expected to be received by the WD. In some embodiments, the radio interface is further configured to receive from the network node a repetition parameter indicating a number of repetitions of an aperiodic TRS resource set. In some embodiments, the radio interface is further configured to transmit to the network node a repetition pattern request requesting a repetition pattern of TRS resources. In some embodiments, the processing circuitry is further configured to select a TRS periodicity from a set of TRS periodicities and wherein the radio interface is further configured to transmit to the network node an indication of the selected TRS periodicity. In some embodiments, the radio interface is further configured to receive from the network node a prohibition timer and to refrain from transmitting the request for TRS signaling before expiry of the prohibition timer.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system connected via an intermediate network to a host computer according to the principles in the present disclosure;

FIG. 2 is a block diagram of a host computer communicating via a network node with a wireless device over an at least partially wireless connection according to some embodiments of the present disclosure;

FIG. 3 is a flowchart illustrating example methods implemented in a communication system including a host computer, a network node and a wireless device for executing a client application at a wireless device according to some embodiments of the present disclosure;

FIG. 4 is a flowchart illustrating example methods implemented in a communication system including a host computer, a network node and a wireless device for receiving user data at a wireless device according to some embodiments of the present disclosure;

FIG. 5 is a flowchart illustrating example methods implemented in a communication system including a host computer, a network node and a wireless device for receiving user data from the wireless device at a host computer according to some embodiments of the present disclosure;

FIG. 6 is a flowchart illustrating example methods implemented in a communication system including a host computer, a network node and a wireless device for receiving user data at a host computer according to some embodiments of the present disclosure;

FIG. 7 is a flowchart of an example process in a network node for according to some embodiments of the present disclosure;

FIG. 8 is a flowchart of an example process in a wireless device for according to some embodiments of the present disclosure;

FIG. 9 is a flowchart of another example process in a network node for according to some embodiments of the present disclosure; and

FIG. 10 is a flowchart of another example process in a wireless device for according to some embodiments of the present disclosure.

### DETAILED DESCRIPTION

Before describing in detail example embodiments, it is noted that the embodiments reside primarily in combinations of apparatus components and processing steps related to management of communication modes, e.g., using at least one of semi-persistent TRS, aperiodic TRS, TRS transmission(s) based on a WD request. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein may be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein may be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It may be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, may be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

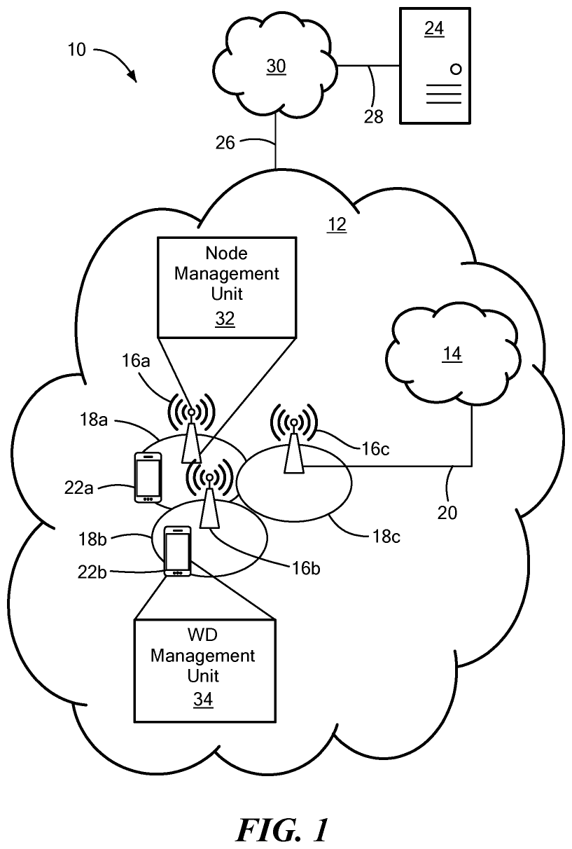

Referring now to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 may be in simultaneous communication and/or configured to separately communicate with more than one network node 16 and more than one type of network node 16. For example, a WD 22 may have dual connectivity with a network node 16 that supports LTE and the same or a different network node 16 that supports NR. As an example, WD 22 may be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a node management unit 32 which is configured to perform any one of the steps and/or methods and/or tasks and/or functions and/or features of the present disclosure, e.g., determine a communication mode between the network node 16 and the WD 22. A wireless device 22 is configured to include a WD management unit 34 which is configured to perform any one of the steps and/or methods and/or tasks and/or functions and/or features of the present disclosure, e.g., receive (and/or determine) a configuration associated with a communication node between the network node 16 and the WD 22.

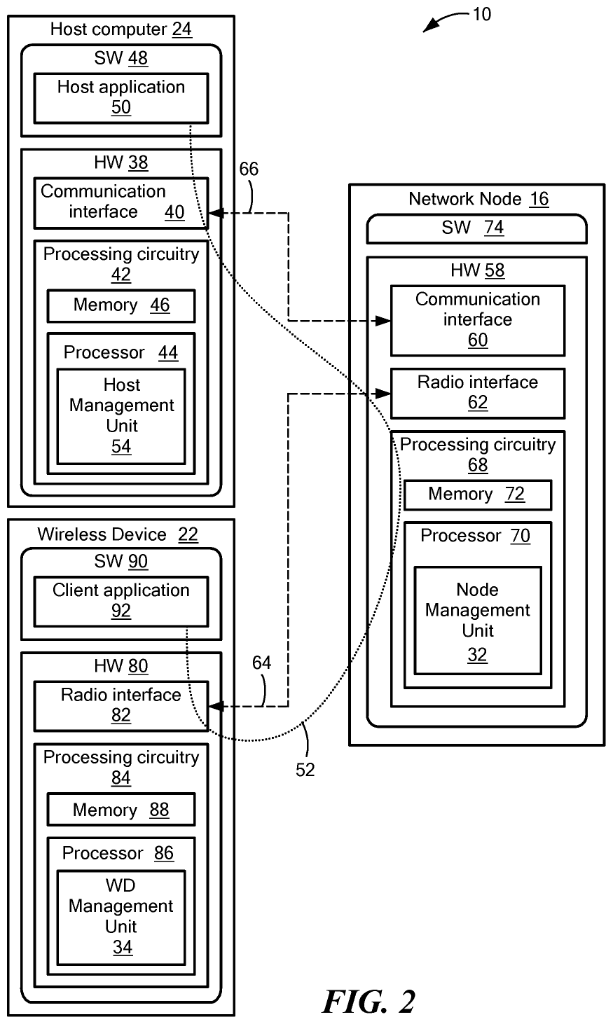

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include a host management unit 54 configured to perform any one of the steps and/or methods and/or tasks and/or functions and/or features of the present disclosure, e.g., enable the service provider to observe/monitor/control/transmit to/receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include node management unit 32 configured to perform any one of the steps and/or methods and/or tasks and/or functions and/or features of the present disclosure, e.g., determine a communication mode between the network node 16 and the WD 22.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a WD management unit 34 configured to perform any one of the steps and/or methods and/or tasks and/or functions and/or features of the present disclosure, e.g., receive (and/or determine) a configuration associated with a communication node between the network node 16 and the WD 22.

In some embodiments, the inner workings of the network node 16, WD 22, and host computer 24 may be as shown in FIG. 2 and independently, the surrounding network topology may be that of FIG. 1.

In FIG. 2, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 1 and 2 show various “units” such as node management unit 32, and WD management unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

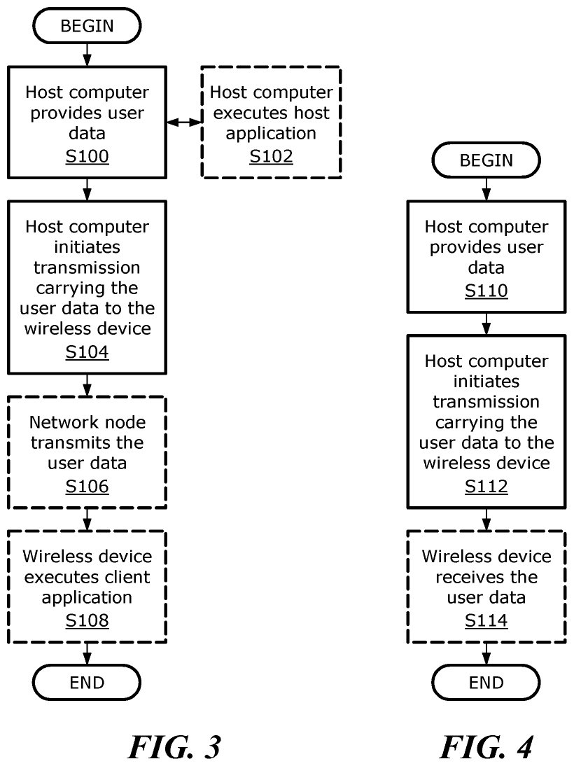

FIG. 3 is a flowchart illustrating an example method implemented in a communication system, such as, for example, the communication system of FIGS. 1 and 2, in accordance with one embodiment. The communication system may include a host computer 24, a network node 16 and a WD 22, which may be those described with reference to FIG. 2. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 4 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

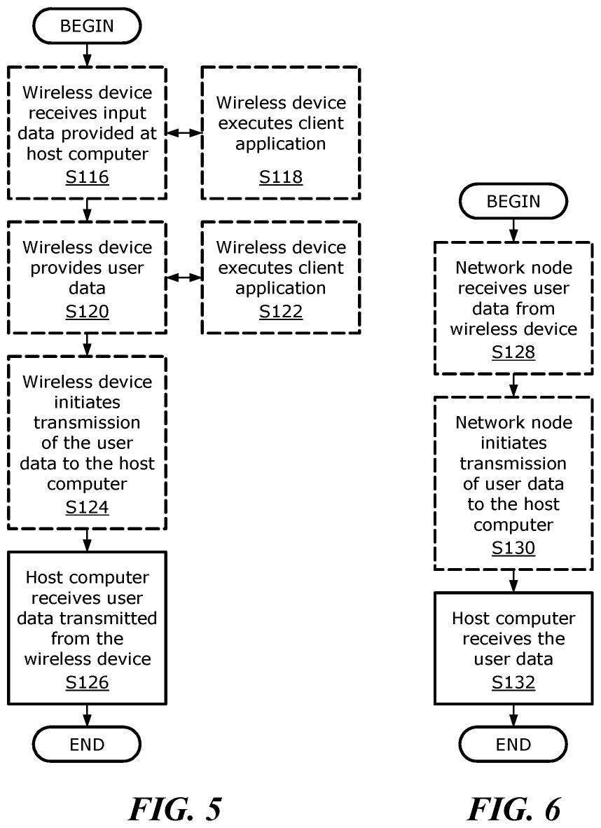

FIG. 5 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 6 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

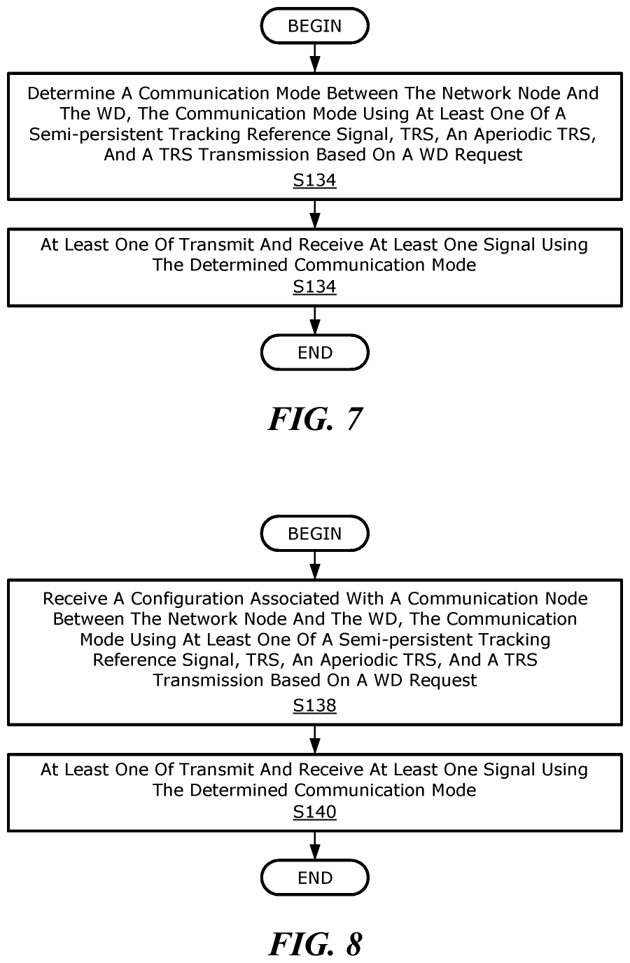

FIG. 7 is a flowchart of an example process in a network node 16. One or more blocks described herein may be performed by one or more elements of network node 16 such as by one or more of processing circuitry 68 (including the node management unit 32), processor 70, radio interface 62 and/or communication interface 60. Network node 16 such as via processing circuitry 68 and/or processor 70 and/or radio interface 62 and/or communication interface 60 is configured to determine (Block S134) a communication mode between the network node 16 and the WD 22, where the communication mode uses at least one of a semi-persistent tracking reference signal, TRS, an aperiodic TRS, and a TRS transmission based on a WD request; and at least one of transmit and receive (Block S136) at least one signal using the determined communication mode.

In some embodiments, using the semi-persistent TRS includes using at least one of open systems interconnection (OSI) layer 1 (L1) signaling and an OSI layer 2 (L2) signaling.

In some other embodiments, the at least one of OSI L1 signaling and OSI L2 signaling is used to at least one of activate and deactivate at least one TRS resource set. In one embodiment, using the aperiodic TRS includes using at least one of L1 signaling and implicit signaling, the at least one of L1 signaling and implicit signaling indicating to the WD 22 that at least one TRS resource set is transmitted in one of: at least one configured occasion; and at least one indicated occasion.

In another embodiment, using the TRS transmission based on the WD request includes receiving from the WD 22 a request for at least one TRS to be transmitted with a prohibit timer.

In some embodiments, the method further includes transmitting to the WD 22 a configuration associated with the determined communication mode.

FIG. 8 is a flowchart of an example process in a wireless device 22 according to some embodiments of the present. One or more blocks described herein may be performed by one or more elements of wireless device 22 such as by one or more of processing circuitry 84 (including the WD management unit 34), processor 86, radio interface 82 and/or communication interface 60. Wireless device 22 such as via processing circuitry 84 and/or processor 86 and/or radio interface 82 is configured to receive (Block S138) a configuration associated with a communication node between the network node 16 and the WD 22, the communication mode using at least one of a semi-persistent tracking reference signal, TRS, an aperiodic TRS, and a TRS transmission based on a WD request; and at least one of transmit and receive (Block S140) at least one signal using the communication mode based at least in part on the received configuration.

In some embodiments, using the semi-persistent TRS includes using at least one of open systems interconnection (OSI) layer 1 (L1) signaling and an OSI layer 2 (L2) signaling.

In some embodiments, the at least one of OSI L1 signaling and OSI L2 signaling is used to at least one of activate and deactivate at least one TRS resource set.

In some embodiments, using the aperiodic TRS includes using at least one of L1 signaling and implicit signaling, the at least one of L1 signaling and implicit signaling indicating to the WD 22 that at least one TRS resource set is transmitted in one of: at least one configured occasion; and at least one indicated occasion.

In some embodiments, using the TRS transmission based on the WD request includes transmitting to the network node 16 a request for at least one TRS to be transmitted with a prohibit timer.

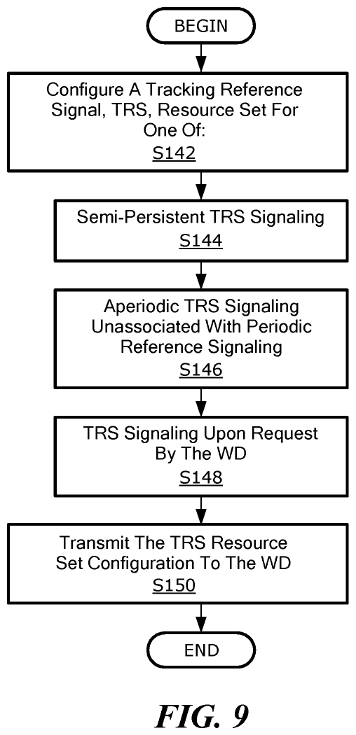

FIG. 9 is a flowchart of an example process in a network node 16. One or more blocks described herein may be performed by one or more elements of network node 16 such as by one or more of processing circuitry 68 (including the node management unit 32), processor 70, radio interface 62 and/or communication interface 60. Network node 16 such as via processing circuitry 68 and/or processor 70 and/or radio interface 62 and/or communication interface 60 is configured to configure a tracking reference signal, TRS, resource set for one of (S142): semi-persistent TRS signaling (S144); aperiodic TRS signaling unassociated with periodic reference signaling (S146); and TRS signaling upon request by the WD 22 (S148); and transmitting the TRS resource set configuration to the WD 22 (S150).

According to this aspect, in some embodiments, the method includes configuring the WD 22 with at least one semi-persistent non-zero power channel state information reference signal, NZP-CSI-RS, resource set. In some embodiments, the method includes one of activating and deactivating at least one semi-persistent TRS resource set by one of L1 and L2 signaling. In some embodiments, one of activating and deactivating at least one semi-persistent TRS resource set is based at least in part on channel conditions. In some embodiments, the method includes configuring the WD 22 with a validity timer indicating a duration of activation of a semi-persistent resource set, the duration of activation being relative to a reference time. In some embodiments, the reference time is a system frame number. In some embodiments, the method includes configuring the WD 22 with a minimum scheduling threshold before which an aperiodic TRS is not expected to be received by the WD 22. In some embodiments, the method includes transmitting to the WD 22 a TRS together with a physical downlink shared channel, PDSCH, scheduling assignment. In some embodiments, the method includes configuring the WD 22 with a repetition parameter indicating a number of repetitions of an aperiodic TRS resource set. In some embodiments, the method includes triggering an aperiodic TRS by downlink control information, DCI, signaling. In some embodiments, the method includes configuring at least one TRS resource set requested by the WD 22. In some embodiments, the method includes configuring a repetition pattern of TRS resources, the repetition pattern being requested by the WD 22. In some embodiments, the method includes configuring the WD 22 with a set of TRS periodicities from which a TRS periodicity is selected by the WD 22. In some embodiments, the method includes transmitting to the WD 22 the TRS with the TRS periodicity selected by the WD 22. In some embodiments, the method includes configuring the WD 22 with a prohibition timer prohibiting the WD 22 from transmitting the request for TRS signaling before expiry of the prohibition timer.

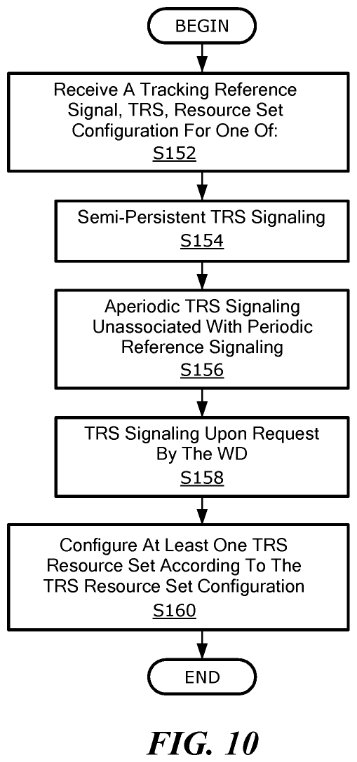

FIG. 10 is a flowchart of an example process in a wireless device 22 according to some embodiments of the present. One or more blocks described herein may be performed by one or more elements of wireless device 22 such as by one or more of processing circuitry 84 (including the WD management unit 34), processor 86, radio interface 82 and/or communication interface 60. Wireless device 22 such as via processing circuitry 84 and/or processor 86 and/or radio interface 82 is configured to receiving a tracking reference signal, TRS, resource set configuration for one of (S152): semi-persistent TRS signaling (S154); aperiodic TRS signaling unassociated with periodic reference signaling (S156); and TRS signaling upon request by the WD 22 (S158). The method also includes configuring at least one TRS resource set according to the TRS resource set configuration (S160).

According to this aspect, in some embodiments, the method includes receiving from the network node an instruction to one of activate and deactivate at least one semi-persistent TRS resource set by one of L1 and L2 signaling. In some embodiments, the method includes receiving from the network node a validity timer indicating a duration of activation of a semi-persistent resource set and activating the semi-persistent resource set for the duration. In some embodiments, the duration of activation is relative to a system frame number. In some embodiments, the method includes receiving from the network node a minimum scheduling threshold before which an aperiodic TRS is not expected to be received by the WD 22. In some embodiments, the method includes receiving from the network node a repetition parameter indicating a number of repetitions of an aperiodic TRS resource set. In some embodiments, the method includes transmitting to the network node a repetition pattern request requesting a repetition pattern of TRS resources. In some embodiments, the method includes selecting a TRS periodicity from a set of TRS periodicities and transmitting to the network node an indication of the selected TRS periodicity. In some embodiments, the method includes receiving from the network node a prohibition timer and refraining from transmitting the request for TRS signaling before expiry of the prohibition timer.

Having described the general process flow of arrangements of the disclosure and having provided examples of hardware and software arrangements for implementing the processes and functions of the disclosure, the sections below provide details and examples of arrangements for aperiodic and semi-persistent tracking reference signals, e.g., using semi-persistent TRS, aperiodic TRS, TRS transmission(s) based on a WD request, etc.

### Embodiment 1: Semi-Persistent TRS

In some embodiments, the TRS is configured as a semi-persistent reference signal (RS). In other words, the WD 22 may be configured with one or more NZP-CSI-RS resource (sets) which are further configured with trs-info parameter configured with “true.” Additionally, the resource (sets) may be configured to be semi-persistent. Therefore, L1 or L2 (i.e., OSI L1 and L2) based mechanisms may be used to activate and/or deactivate one or TRS resource (sets). Examples of L1 or L2 mechanisms are DCI or medium access control (MAC) control element (CE) based signaling.

In one example, the WD 22 may be configured with a first semi-persistent TRS resource set, and a second semi-persistent TRS resource set. the WD 22 may be additionally configured and/or pre-configured to apply MAC CE or DCI indication to consider either or both of the TRS resource sets as activated or deactivated. For example, the WD 22 may receive a MAC CE or DCI based indication that from a reference point, e.g., the system frame number (SFN) in which the indication is received, and potentially with an application delay. The first TRS resource set may be deactivated. The second TRS set may be activated. In another example, both sets may be activated, or both are deactivated.

In a more detailed example, the first TRS resource set may be configured with a periodicity of 10 ms, and the second TRS set may be configured with periodicity of 40 ms. The network node 16 may then use MAC CE or DCI signaling in order to activate the first TRS set (e.g., when the WD 22 needs to stay in synch, when other RSs are not frequent, when the WD 22 is in a worse coverage, thereby needing more accurate synch, or when the WD 22 receives a burst of data). However, when the WD 22 has access to more frequent RSs, e.g., DM-RS, or when the WD 22 coverage is good, then the network node 16 may deactivate the first TRS set, and optionally activate the second set.

In another example, the first and the second TRS set may be different at least in the configured TCI state. The WD 22 may receive a MAC CE or DCI signaling indicating whether the first and/or second TRS set is activated or deactivated (e.g., again from a reference point and potentially with an application delay). This is useful in many situations, e.g., when the WD 22 is covered within the TCI state or beam of the first set but not the second set and thus the transmission of the second set is redundant. Therefore, the network node 16 may indicate to the WD 22 that the first set is active but not the second set, and if the WD 22 is mobile, then the network node 16 may activate both.

The MAC CE or DCI based signaling may be configured to be WD specific, group based, and/or cell/area specific signaling. The DCI may be based on scheduling or non-scheduling DCIs and/or a new DCI format. Higher layer signaling, e.g., RRC signaling, and/or system information block (SIB) may be used to configure the WD 22 to perform one or more steps described herein, e.g., DCI or MAC-CE, or the DCI format, as well as DCI size, start and length of the indication bitfield, etc. Further, start and/or length of the bitfield may be pre-configured. For example, the length of the bitfield may depend on the number of TRS resource sets and/or group of sets configured.

In addition, the WD 22 may be configured with a validity timer and/or a validity timer per set and/or per group of sets. As such the WD 22 may receive an indication that e.g., the first TRS set is activated, but only within the configured validity timer. The validity timer may be in terms of a time unit, e.g., X ms, Y slots, etc., and with a reference point, e.g., the SFN within which the indication is received. In another example, the validity timer is applicable to the case where one or more TRS resource (sets) are activated, and not the deactivation case. In other words, once a resource (set) is deactivated, then it is deactivated until activated again. In one other example, if the validity timer is not explicitly configured, then it is a default value, e.g., 10 ms.

### Embodiment 2: Aperiodic TRS

In some embodiments, the WD 22 may receive on or more TRS resource (sets), which are particularly configured to be aperiodic. Typically, it may only be possible to configure aperiodic TRS if the WD 22 is additionally configured with at least a set of periodic TRS resources in FR2. In this embodiment, the network node 16 may configure the WD 22 with (e.g., only with) one or more aperiodic TRS resource (sets) even if no periodic TRS resource set is configured. There is no requirement with association of an aperiodic TRS set to a periodic set, e.g., in terms of quasi co-location (QCL) relations, etc. In one example, the WD 22 may receive a configuration of an aperiodic TRS set, and furthermore, the WD 22 may be configured with an L1 based signaling technique such as DCI based signaling to trigger the TRS set. In another example, particularly when a DCI based mechanism is used to trigger the TRS set and the WD 22 is additionally configured with a minimum scheduling threshold (e.g., a non-zero minim k0 or k2 value), then the WD 22 expects the TRS set to be received after (e.g., only after) the currently applied minimum k0 value. Alternatively, the WD 22 may not be configured with an aperiodic triggering offset which is lower than the currently configured minimum k0 value. In another example, the aperiodic TRS offset may be lower than the minimum K0 value, such that the network node 16 may transmit a TRS together with scheduling a PDSCH, particularly for higher modulation orders. In one example, this may be allowed if MCS is higher than a specific index, e.g., for more than 64QAM (Quadrature Amplitude Modulation) constellations.

In another example, the aperiodic TRS triggering may entail a repetition parameter indicating how many more times one or more TRS resource (set) s are repeated once triggered. The repetition may be on a periodic basis, e.g., every 10 ms, 20 ms, or 10 slots, 20 slots, or based on a pattern which may not be necessarily periodic. Alternatively, the repetition parameter may be part of the configuration of the TRS resource (set).

In another example, the aperiodic TRS may be triggered implicitly, e.g., if one or more specific scheduling or non-scheduling DCI is received. The condition may additionally indicate which TRS resource (set) s are triggered, e.g., if the DCI is received in a specific TCI state, then the TRS resource (set) s associated with that TCI state are triggered. Other conditions may be: the start of ON duration timer (when the WD 22 is configured with connected mode discontinuous reception (C-DRX)); after expiration of a PDCCH skipping duration if the WD 22 is configured with PDCCH skipping during active time; when the WD 22 monitors PDCCH with a synchronization signal (SS) periodicity longer than a specific threshold with no other PDCCH monitoring occasions (Mos) in between; and/or after receiving a wake-up signal (WUS) indicating the WD 22 to monitor PDCCH.

The triggering DCI may be an existing DCI, e.g., DCI 1-1/1-2/0-1/0-2 or a new DCI format, e.g., designed for power saving. The radio network temporary identifier (RNTI) may be WD specific, group-common or cell/area specific. Considering that TRS is typically broadcast, group common signaling may be used, and although DCI may be monitored in both WD-specific search space (USS) or common search space (CSS), CSS may be the preferred choice.

### Embodiment 3: TRS Transmission Based on a WD Request

In some embodiments, the WD 22 may be configured with one or more TRS resource (sets). The WD 22 may also be configured to request from the network node 16 that one or more specific TRS resource (set) s are to be transmitted. Furthermore, the WD 22 may be configured to be able to request the TRS resource (set) s to be transmitted based on a specific repetition pattern and/or with a specific periodicity and/or for a specific validity timer and/or within a specific TCI state/beam. The WD 22 may also indicate its preferred reference time, to start the transmission of TRS.

In one example, the WD 22 may be configured to be able to request TRS with one of multiple possible requested periodicities. The possible requested periodicities may be predetermined values and/or may be configured by the network node 16 (where the network node 16 configured values are the subset of the possible values of the predetermined values). The requested TRS periodicity bitfield may contain a codepoint which points to which periodicity is requested by the WD 22. For example, the WD 22 may be configured with 10 ms and 20 ms of possible requested TRS periodicity. The bitfield value of 0 and 1 may then represent that the WD 22 requests a TRS with a periodicity of 10 ms and 20 ms, respectively. The same mechanism may also be used for the TRS number of repetitions, validity timer, etc. Note that in this example, the requested TRS bitfield may contain multiple sub bitfields, e.g., bitfield for requested TRS periodicity, bitfield for requested TRS number of repetitions, requested TRS validity timer, etc.

In another example, the WD 22 may be configured (e.g., by the network node 16 such as network node 16 and/or based on predetermined configurations) with a table containing the possible requested parameter with its configured value. For example, the WD 22 may be configured with a tables of one or more rows, e.g., 4 rows. The bitfield values of 00, 01, 10, and 11, may then represent that the WD 22 requests the first, the second, the third, or the fourth row of the table, respectively. Nonlimiting example parameters and example values of the table may be as follows

TABLE 2
Configurations including TRS periodicity and validity timers.

| Conf. | Requested TRS | Requested TRS |
|---|---|---|
| number | periodicity | validity timer |
| 00 | 10 ms | 80 ms |
| 11 | 20 ms | 80 ms |
| 10 | 20 ms | 160 ms |
| 11 | 20 ms | 320 ms |

The WD 22 may be configured to be able to transmit the requests over PUCCH or PUSCH, e.g., as configured grants and/or when triggered by the network node 16, or as a WD assistance information (UAI), or over PRACH.

Further, the WD 22 may be configured with a prohibition timer, i.e., the WD 22 may transmit (e.g., only transmit) a new request upon expiration of the prohibition timer. For example, the WD 22 may be configured with a prohibition timer of 1 second, and thus, the WD 22 may only send a new request for TRS if the 1-second prohibition timer is expired from the last request, in some embodiments.

Using TRS transmission based on a WD request may be useful at least when the WD 22 moves from coverage of one TRS set to another one, and thus, may indicate to the network node 16 the need for the new TRS and/or that the WD 22 expects to be scheduled with higher order modulations. It may also be advantageous for the network node 16, because the network node 16 would not have to transmit the TRS unnecessarily, thereby saving energy. In some embodiments, the WD 22 request is considered a preference, and thus, it is up to the network node 16 to follow the preference of the WD 22 or not.

Some embodiments may include one or more of the following:

Embodiment A1. A network node configured to communicate with a wireless device, WD, the network node configured to, and/or comprising a radio interface and/or comprising processing circuitry configured to:
determine a communication mode between the network node and the WD, the communication mode using at least one of a semi-persistent tracking reference signal, TRS, an aperiodic TRS, and a TRS transmission based on a WD request; and
at least one of transmit and receive at least one signal using the determined communication mode.

Embodiment A2. The network node of Embodiment A1, wherein using the semi-persistent TRS includes using at least one of open systems interconnection, OSI, layer 1, L1 signaling and an OSI layer 2, L2, signaling.

Embodiment A3. The network node of Embodiment A2, wherein the at least one of OSI L1 signaling and OSI L2 signaling is used to at least one of activate and deactivate at least one TRS resource set.

Embodiment A4. The network node of any one of Embodiments A1-A3, wherein using the aperiodic TRS includes using at least one of L1 signaling and implicit signaling, the at least one of L1 signaling and implicit signaling indicating to the WD that at least one TRS resource set is transmitted in one of:
at least one configured occasion; and
at least one indicated occasion.

Embodiment A5. The network node of any one of Embodiments A1-A4, wherein using the TRS transmission based on the WD request includes receiving from the WD a request for at least one TRS to be transmitted with a prohibit timer.

Embodiment A6. The network node of any one of Embodiments A1-A5, wherein the radio interface is further configured to:
transmit to the WD a configuration associated with the determined communication mode.

Embodiment B1. A method implemented in a network node configured to communicate with a wireless device, WD, the method comprising:
determining a communication mode between the network node and the WD, the communication mode using at least one of a semi-persistent tracking reference signal, TRS, an aperiodic TRS, and a TRS transmission based on a WD request; and
at least one of transmitting and receiving at least one signal using the determined communication mode.

Embodiment B2. The method of Embodiment B1, wherein using the semi-persistent TRS includes using at least one of open systems interconnection, OSI, layer 1, L1 signaling and an OSI layer 2, L2, signaling.

Embodiment B3. The method of Embodiment B2, wherein the at least one of OSI L1 signaling and OSI L2 signaling is used to at least one of activate and deactivate at least one TRS resource set.

Embodiment B4. The method of any one of Embodiments B1-B3, wherein using the aperiodic TRS includes using at least one of L1 signaling and implicit signaling, the at least one of L1 signaling and implicit signaling indicating to the WD that at least one TRS resource set is transmitted in one of:
at least one configured occasion; and
at least one indicated occasion.

Embodiment B5. The method of any one of Embodiments B1-B4, wherein using the TRS transmission based on the WD request includes receiving from the WD a request for at least one TRS to be transmitted with a prohibit timer.

Embodiment B6. The method of any one of Embodiments B1-B5, wherein the method further includes:
transmitting to the WD a configuration associated with the determined communication mode.

Embodiment C1. A wireless device, WD, configured to communicate with a network node, the WD configured to, and/or comprising a radio interface and/or processing circuitry configured to:
receive a configuration associated with a communication node between the network node and the WD, the communication mode using at least one of a semi-persistent tracking reference signal, TRS, an aperiodic TRS, and a TRS transmission based on a WD request; and
at least one of transmit and receive at least one signal using the communication mode based at least in part on the received configuration.

Embodiment C2. The WD of Embodiment C1, wherein using the semi-persistent TRS includes using at least one of open systems interconnection, OSI, layer 1,
L1 signaling and an OSI layer 2, L2, signaling.

Embodiment C3. The WD of Embodiment C2, wherein the at least one of OSI L1 signaling and OSI L2 signaling is used to at least one of activate and deactivate at least one TRS resource set.

Embodiment C4. The WD of any one of Embodiments C1-C3, wherein using the aperiodic TRS includes using at least one of L1 signaling and implicit signaling, the at least one of L1 signaling and implicit signaling indicating to the WD that at least one TRS resource set is transmitted in one of:
at least one configured occasion; and
at least one indicated occasion.

Embodiment C5. The WD of any one of Embodiments C1-C4, wherein using the TRS transmission based on the WD request includes transmitting to the network node a request for at least one TRS to be transmitted with a prohibit timer.

Embodiment D1. A method implemented in a wireless device, WD, configured to communicate with a network node, the method comprising:
receiving a configuration associated with a communication node between the network node and the WD, the communication mode using at least one of a semi-persistent tracking reference signal, TRS, an aperiodic TRS, and a TRS transmission based on a WD request; and
at least one of transmitting and receiving at least one signal using the communication mode based at least in part on the received configuration.

Embodiment D2. The method of Embodiment D1, wherein using the semi-persistent TRS includes using at least one of open systems interconnection, OSI, layer 1, L1 signaling and an OSI layer 2, L2, signaling.

Embodiment D3. The method of Embodiment D2, wherein the at least one of OSI L1 signaling and OSI L2 signaling is used to at least one of activate and deactivate at least one TRS resource set.

Embodiment D4. The method of any one of Embodiments C1-D3, wherein using the aperiodic TRS includes using at least one of L1 signaling and implicit signaling, the at least one of L1 signaling and implicit signaling indicating to the WD that at least one TRS resource set is transmitted in one of:
at least one configured occasion; and
at least one indicated occasion.

Embodiment D5. The method of any one of Embodiments D1-D4, wherein using the TRS transmission based on the WD request includes transmitting to the network node a request for at least one TRS to be transmitted with a prohibit timer.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that may be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that may direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments may be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

| | |
|---|---|
| CSI-RS | Channel State Information-Reference Signal |
| DCI | Downlink Control Information |
| NW | Network |
| PEI | Paging Early Indicator |
| PO | Paging Occasion |
| SI | System Information |
| SIB | System Information Block |
| SSS | Secondary Synchronization Signal |
| TRS | Tracking Reference Signal or CSI-RS for tracking |
| TRSA | TRS Availability |
| UE | User Equipment |
| WD | Wireless Device |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method in a network node configured to communicate with a wireless device, WD, the method comprising:
configuring a tracking reference signal, TRS, resource set for one of:
semi-persistent TRS signaling;
aperiodic TRS signaling unassociated with periodic reference signaling; and
TRS signaling upon request by the WD; and
transmitting the TRS resource set configuration to the WD.

2.-15. (canceled)

16. A network node configured to communicate with a wireless device, WD, the network node comprising:
processing circuitry configured to configure a tracking reference signal, TRS, resource set for one of:
semi-persistent TRS signaling;
aperiodic TRS signaling unassociated with periodic reference signaling; and
TRS signaling upon request by the WD; and
a radio interface in communication with the processing circuitry and configured to transmit the TRS resource set configuration to the WD.

17. The network node of claim 16, wherein the processing circuitry is further configured to configure the WD with at least one semi-persistent non-zero power channel state information reference signal, NZP-CSI-RS, resource set.

18.-30. (canceled)

31. A method in a wireless device, WD, configured to communicate with a network node, the method comprising:
receiving a tracking reference signal, TRS, resource set configuration for one of:
semi-persistent TRS signaling;
aperiodic TRS signaling unassociated with periodic reference signaling; and
TRS signaling upon request by the WD; and
configuring at least one TRS resource set according to the TRS resource set configuration.

32. The method of claim 31, further comprising receiving from the network node one or both of:
an instruction to one of activate and deactivate at least one semi-persistent TRS resource set by one of L1 and L2 signaling; and
a validity timer indicating a duration of activation of a semi-persistent resource set and activating the semi-persistent resource set for the duration.

33. (canceled)

34. The method of claim 32, wherein the duration of activation is relative to a system frame number.

35. The method of claim 31, further comprising receiving from the network node a minimum scheduling threshold before which an aperiodic TRS is not expected to be received by the WD.

36. The method of claim 31, further comprising receiving from the network node a repetition parameter indicating a number of repetitions of an aperiodic TRS resource set.

37. The method of claim 31, further comprising transmitting to the network node a repetition pattern request requesting a repetition pattern of TRS resources.

38. The method of claim 31, further comprising selecting a TRS periodicity from a set of TRS periodicities and transmitting to the network node an indication of the selected TRS periodicity.

39. The method of claim 31, further comprising receiving from the network node a prohibition timer and refraining from transmitting the request for TRS signaling before expiry of the prohibition timer.

40. A wireless device, WD, configured to communicate with a network node, the WD comprising:
a radio interface configured to receive a tracking reference signal, TRS, resource set configuration for one of:
semi-persistent TRS signaling;
aperiodic TRS signaling unassociated with periodic reference signaling; and
TRS signaling upon request by the WD; and
processing circuitry in communication with the radio interface and configured to configure at least one TRS resource set according to the TRS resource set configuration.

41. The WD of claim 40, wherein the radio interface is further configured to receive from the network node an instruction to one of activate and deactivate at least one semi-persistent TRS resource set by one of L1 and L2 signaling.

42. The WD of claim 40, wherein the radio interface is further configured to receive from the network node a validity timer indicating a duration of activation of a semi-persistent resource set and wherein the processing circuitry is further configured to activate the semi-persistent resource set for the duration.

43. The WD of claim 41, wherein the duration of activation is relative to a system frame number.

44. The WD of claim 41, wherein the radio interface is further configured to receive from the network node a minimum scheduling threshold before which an aperiodic TRS is not expected to be received by the WD.

45. The WD of claim 41, wherein the radio interface is further configured to receive from the network node a repetition parameter indicating a number of repetitions of an aperiodic TRS resource set.

46. The WD of claim 41, wherein the radio interface is further configured to transmit to the network node a repetition pattern request requesting a repetition pattern of TRS resources.

47. The WD of claim 41, wherein the processing circuitry is further configured to select a TRS periodicity from a set of TRS periodicities and wherein the radio interface is further configured to transmit to the network node an indication of the selected TRS periodicity.

48. The WD of claim 41, wherein the radio interface is further configured to receive from the network node a prohibition timer and to refrain from transmitting the request for TRS signaling before expiry of the prohibition timer.
